(19) United States
(12) Patent Application Publication
(10) Pub. No.: US 2008/0121616 A1
(43) Pub. Date: May 29, 2008

(54) Spatial-frequency tripling and quadrupling processes for lithographic application

(76) Inventor: Yijian Chen, Albany, CA (US)

Correspondence Address: Yijian Chen, 1049 Talbot Avenue, Albany, CA, 94706, US

(21) Appl. No.: 11/591,056

(22) Filed: Nov. 2, 2006

(51) Int. Cl. B44C 1/22

(52) U.S. Cl. 216/41

(57) ABSTRACT

A number of spatial-frequency tripling and quadrupling technologies are invented to pattern features with their pitch size reduced to ⅓ and ¼ of the minimum pitch size resolvable with a conventional lithographic technology. Both spatial-frequency tripling and quadrupling can be achieved with two processes. Each process comprises a series of lithographic and etching steps, wherein the more accurate control of the critical dimension (CD) of patterned features is achieved by deposition, etching and using a hard mask. They provide production worthy methods for the whole semiconductor industry to continue device scaling to sub-32 nm generations with no need of expensive next-generation lithography technologies.

### BACKGROUND OF THE INVENTION

Optical DUV (deep ultraviolet) immersion (water) lithography has the capability of printing features down to half-pitch 40 nm. The potential next-generation lithography (NGL) technologies include EUV (extreme ultraviolet), maskless, and nano-imprint lithography [1]. However, all these NGL technologies face their own technological challenges and still need a long development time before they can be applied to high-throughput manufacturing.

A number of spatial-frequency tripling and quadrupling technologies are invented to pattern features with their pitch size reduced to ⅓ and ¼ of the minimum pitch size resolvable with a conventional lithographic technology. They provide production worthy methods for the whole semiconductor industry to continue device scaling to sub-32 nm node with no need of NGL.

### DETAILED DESCRIPTION OF THE INVENTION

Both spatial-frequency tripling and quadrupling can be achieved with two processes. The processes of spatial-frequency quadrupling will be demonstrated first. As shown FIG. 1(1), we start with a stack of several layers including hard-mask and targeted layers on top of the substrate. It is important that we choose a hard-mask material with high etching selectivity such that its shape will not change or only slight change will occur after the layers underneath are etched in both dry and wet methods. A standard lithographic process is used in step (2) to print resist features with their pitch size (e.g., 5 F+3 F=8 F) equal to the minimum pitch size printable with a lithographic tool. A following anisotropic plasma etching will transfer the resist pattern to the hard-mask and targeted layers as shown in step (3). After this, an isotropic etching (which can be either wet or dry, but will not attack the hard-mask layer) will undercut the targeted layer such that the width of the left targeted layer underneath the hard-mask layer is exactly IF as shown in step (4). A deposition (step (5)) of the sacrificial material will fill the undercut cavities followed by an anisotropic plasma etching to remove the sacrificial material in the trenches as shown in step (6). The width of the sacrificial material underneath the hard-mask layer is 2 F on both sides assuming the hard-mask layer does not change its shape during the etchings. Another isotropic etching (which can be either wet or dry, but will not attack the hard-mask layer) will etch the sacrificial material such that the width of the left sacrificial layers underneath the hard-mask layer is exactly 1 F as shown in step (7). After this, the targeted material will be deposited to fill the undercut cavities as shown in step (8), followed by an anisotropic plasma etching to remove the targeted material in the trenches as shown in step (9). Then a sacrificial layer will be deposited in step (10) and etched back in step (11) to form the sacrificial side walls leaving the trenches' width of about 1 F. A following deposition of the targeted material will fill these trenches as shown in step (12). Finally, a CMP process will be used to polish off the top layers to expose the targeted and sacrificial materials as shown in step (13). After releasing the sacrificial material by either wet or dry etching, a dense line/space structure with pitch size equal to 2 F is obtained and shown in step (14). This pitch size (2 F) is ¼ of the original pitch size (8 F) which corresponds to the minimum resolution limit of a conventional lithographic system.

The second process to achieve the spatial-frequency quadrupling is shown FIG. 2. We start with a stack of several layers including hard-mask and sacrificial layers on top of the substrate. The difference between this process and the previous one is that the sacrificial material instead of the targeted material is deposited on the substrate. It is important to choose a hard-mask material with high etching selectivity such that its shape will not change or only slight change will occur after the layers underneath are etched in both dry and wet methods. A standard lithographic process is used in step (2) to print resist features with their pitch size (e.g., 5 F+3 F=8 F) equal to the minimum pitch size printable with a lithographic tool. A following anisotropic plasma etching will transfer the resist pattern to the hard-mask and sacrificial layers as shown in step (3). After this, an isotropic etching (which can be either wet or dry, but will not attack the hard-mask layer) will undercut the sacrificial layer such that the width of the left sacrificial layer underneath the hard-mask layer is exactly 1 F as shown in step (4). A deposition (step (5)) of the targeted material will fill the undercut cavities followed by an anisotropic plasma etching to remove the targeted material in the trenches as shown in step (6). The width of the targeted material underneath the hard-mask layer is 2 F on both sides assuming the hard-mask layer does not change its shape during the etchings. Another isotropic etching (which can be either wet or dry, but will not attack the hard-mask layer) will etch the targeted material such that the width of the left targeted layers underneath the hard-mask layer is exactly 1 F as shown in step (7). After this, the sacrificial material will be deposited to fill the undercut cavities as shown in step (8), followed by an anisotropic plasma etching to remove the sacrificial materials in the trenches as shown in step (9). Then a targeted layer will be deposited in step (10) and etched back in step (11) to form the side walls leaving the trenches' width of about 1 F. Finally, a CMP process will be used to polish off the top layers to expose the targeted and sacrificial materials as shown in step (12). After releasing the sacrificial material by either wet or dry etching, a dense line/space structure with pitch size equal to 2 F is obtained and shown in step (13). This pitch size (2 F) is ¼ of the original pitch size (8 F) which corresponds to the minimum resolution limit of a conventional lithographic system.

The spatial-frequency tripling processes are similar to the quadrupling processes except that less undercut etching and filling steps are needed. As shown FIG. 3, we start with a stack of several layers including hard-mask and targeted layers on top of the substrate. Again it is important to choose a hard-mask material with high etching selectivity such that its shape will not change or only slight change will occur after the layers underneath are etched in both dry and wet methods. A standard lithographic process is used in step (2) to print resist features with their pitch size (e.g., 3 F+3 F=6 F) equal to the minimum pitch size resolvable with a lithographic tool. A following anisotropic plasma etching will transfer the resist pattern to the hard-mask and targeted layers as shown in step (3). After this, an isotropic etching (which can be either wet or dry, but will not attack the hard-mask layer) will undercut the targeted layer such that the width of the left targeted layer underneath the hard-mask layer is exactly 1 F as shown in step (4). A deposition (step (5)) of the sacrificial material will fill the undercut cavities followed by an anisotropic plasma etching to remove the sacrificial materials in the trenches as shown in step (6). The width of the sacrificial material underneath the hard-mask layer is 1 F on both sides assuming the hard-mask layer does not change its shape during the etchings. After this, the targeted material will be deposited to fill the trenches as shown in step (7), followed by an anisotropic plasma etching to form the targeted-material side walls leaving the trenches' width of about 1 F as shown in step (8). Finally, a CMP process will be used to polish off the top layers to expose the targeted and sacrificial materials as shown in step (9). After releasing the sacrificial material by either wet or dry etching, a dense line/space structure with pitch size equal to 2 F is obtained and shown in step (10). This pitch size (2 F) is ⅓ of the original pitch size (6 F) which corresponds to the minimum resolution limit of a conventional lithographic system. The second process to achieve the spatial-frequency tripling is shown FIG. 4. We start with a stack of several layers including hard-mask and sacrificial layers on top of the substrate. A hard-mask material with high etching selectivity should be chosen such that its shape will not change or only slight change will occur after the layers underneath are etched in both dry and wet methods. A standard lithographic process is used in step (2) to print resist features with their pitch size (e.g., 3 F+3 F=6 F) equal to the minimum pitch size resolvable with a lithographic tool. A following anisotropic plasma etching will transfer the resist pattern to the hard-mask and sacrificial layers as shown in step (3). After this, an isotropic etching (which can be either wet or dry, but will not attack the hard-mask layer) will undercut the sacrificial layer such that the width of the left sacrificial layer underneath the hard-mask layer is exactly 1 F as shown in step (4). A deposition (step (5)) of the targeted material will fill the undercut cavities followed by an anisotropic plasma etching to remove the targeted materials in the trenches as shown in step (6). The width of the targeted material underneath the hard-mask layer is 1 F on both sides assuming the hard-mask layer does not change its shape during the etchings. After this, the sacrificial material will be deposited to fill the trenches as shown in step (7), followed by an anisotropic plasma etching to form the sacrificial side walls leaving the trenches' width of about 1 F as shown in step (8). These trenches are filled with the targeted material in step (9). Finally, a CMP process is used to polish off the top layers to expose the targeted and sacrificial materials. After releasing the sacrificial material by either wet or dry etching, a dense line/space structure with pitch size equal to 2 F is obtained and shown in step (10). This pitch size (2 F) is ⅓ of the original pitch size (6 F) which corresponds to the minimum resolution limit of a conventional lithographic system.

### BRIEF DESCRIPTION OF THE FIGURES

FIG. 1. depicts one spatial-frequency quadrupling process to pattern features with pitch size reduced to ¼ of the minimum pitch size resolvable with a lithographic technology.

FIG. 2. depicts another spatial-frequency quadrupling process to pattern features with pitch size reduced to ¼ of the minimum pitch size resolvable with a lithographic technology.

FIG. 3. depicts one spatial-frequency tripling process to pattern features with their pitch size reduced to ⅓ of the minimum pitch size resolvable with a lithographic technology.

FIG. 4. depicts another spatial-frequency tripling process to pattern features with their pitch size reduced to ⅓ of the minimum pitch size resolvable with a lithographic technology.

### REFERENCES

[1] International Technology Roadmap for Semiconductors (ITRS), 2005 version

Yijian Chen claims that he invents a number of spatial-frequency tripling and quadrupling technologies are invented to pattern features with their pitch size reduced to ⅓ and ¼ of the minimum pitch size resolvable with a conventional lithographic technology. They provide production worthy methods for the whole semiconductor industry to continue device scaling to sub-32 nm node with no need of NGL.

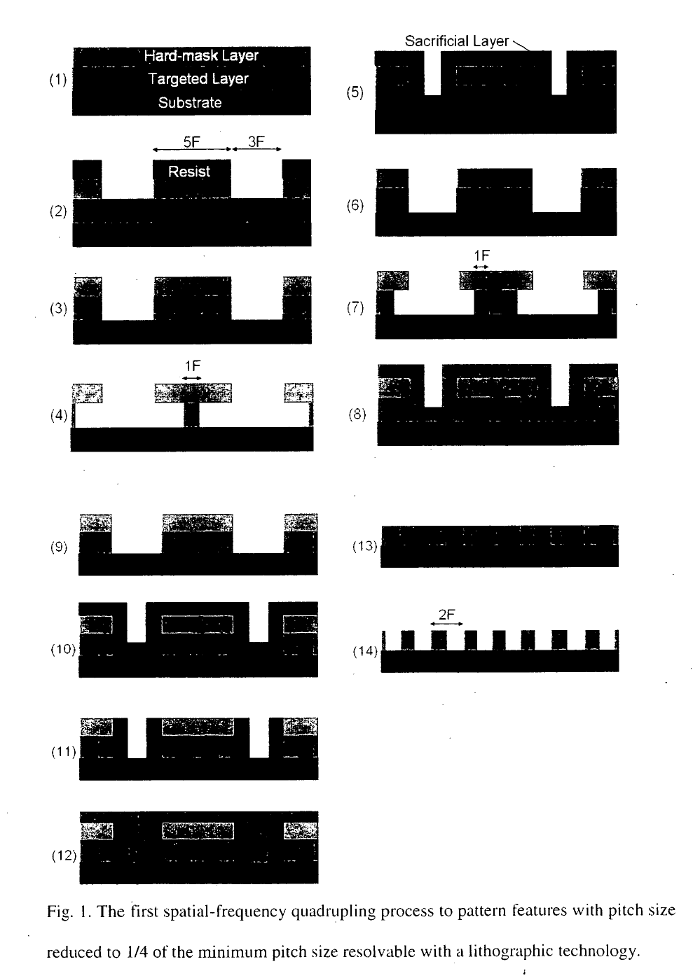

1. The first processes of spatial-frequency quadrupling is shown in FIG. 1, the process comprising:
a. A stack of several layers including hard-mask and targeted layers are deposited on top of the substrate as shown in step (1).
b. We choose a hard-mask material with high etching selectivity such that its shape will not change or only slight change will occur after the layers underneath are etched in both dry and wet methods.
c. A standard lithographic process is used in step (2) to print resist features with their pitch size (e.g., 5 F+3 F=8 F) equal to the minimum pitch size printable with a lithographic tool.
d. A following anisotropic plasma etching will transfer the resist pattern to the hard-mask and targeted layers as shown in step (3).
e. After this, an isotropic etching (which can be either wet or dry, but will not attack the hard-mask layer) will undercut the targeted layer such that the width of the left targeted layer underneath the hard-mask layer is exactly 1 F as shown in step (4).
f. A deposition (step (5)) of the sacrificial material will fill the undercut cavities followed by an anisotropic plasma etching to remove the sacrificial material in the trenches as shown in step (6). The width of the sacrificial material underneath the hard-mask layer is 2 F on both sides assuming the hard-mask layer does not change its shape during the etchings.
g. Another isotropic etching (which can be either wet or dry, but will not attack the hard-mask layer) will etch the sacrificial material such that the width of the left sacrificial layers underneath the hard-mask layer is exactly 1 F as shown in step (7).
h. After this, the targeted material will be deposited to fill the undercut cavities as shown in step (8), followed by an anisotropic plasma etching to remove the targeted material in the trenches as shown in step (9).
i. Then a sacrificial layer will be deposited in step (10) and etched back in step (11) to form the sacrificial side walls leaving the trenches' width of about 1 F.
j. A following deposition of the targeted material will fill these trenches as shown in step (12).
k. Finally, a CMP process will be used to polish off the top layers to expose the targeted and sacrificial materials as shown in step (13).
l. After releasing the sacrificial material by either wet or dry etching, a dense line/space structure with pitch size equal to 2 F is obtained and shown in step (14). This pitch size (2 F) is ¼ of the original pitch size (8 F) which corresponds to the minimum resolution limit of a conventional lithographic system.

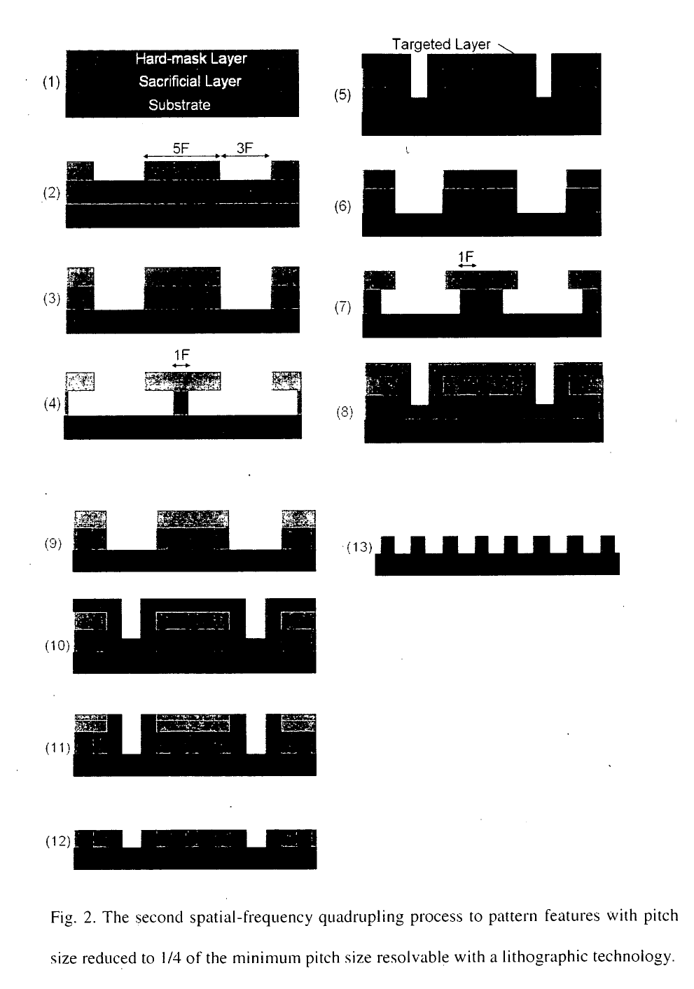

2. The second process to achieve the spatial-frequency quadrupling is shown FIG. 2, the process comprising:
a. A stack of several layers including hard-mask and sacrificial layers are deposited on top of the substrate. The difference between this step and the one of claim 1 is that the sacrificial material instead of the targeted material is deposited on the substrate.
b. It is important to choose a hard-mask material with high etching selectivity such that its shape will not change or only slight change will occur after the layers underneath are etched in both dry and wet methods.
c. A standard lithographic process is used in step (2) to print resist features with their pitch size (e.g., 5 F+3 F=8 F) equal to the minimum pitch size printable with a lithographic tool.
d. A following anisotropic plasma etching will transfer the resist pattern to the hard-mask and sacrificial layers as shown in step (3).
e. After this, an isotropic etching (which can be either wet or dry, but will not attack the hard-mask layer) will undercut the sacrificial layer such that the width of the left sacrificial layer underneath the hard-mask layer is exactly 1 F as shown in step (4).
f. A deposition (step (5)) of the targeted material will fill the undercut cavities followed by an anisotropic plasma etching to remove the targeted material in the trenches as shown in step (6). The width of the targeted material underneath the hard-mask layer is 2 F on both sides assuming the hard-mask layer does not change its shape during the etchings.
g. Another isotropic etching (which can be either wet or dry, but will not attack the hard-mask layer) will etch the targeted material such that the width of the left targeted layers underneath the hard-mask layer is exactly 1 F as shown in step (7).
h. After this, the sacrificial material will be deposited to fill the undercut cavities as shown in step (8), followed by an anisotropic plasma etching to remove the sacrificial materials in the trenches as shown in step (9).
i. Then a targeted layer will be deposited in step (10) and etched back in step (11) to form the side walls leaving the trenches' width of about 1 F.
j. Finally, a CMP process will be used to polish off the top layers to expose the targeted and sacrificial materials as shown in step (12).
k. After releasing the sacrificial material by either wet or dry etching, a dense line/space structure with pitch size equal to 2 F is obtained and shown in step (13). This pitch size (2 F) is ¼ of the original pitch size (8 F) which corresponds to the minimum resolution limit of a conventional lithographic system.

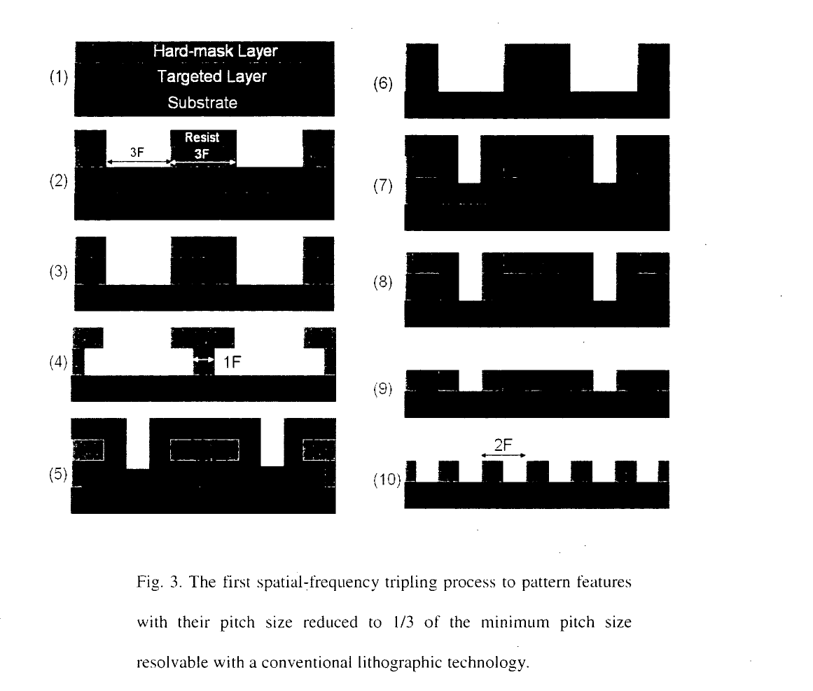

3. The spatial-frequency tripling processes as shown FIG. 3 are similar to the quadrupling processes except that less undercut etching and filling steps are needed, the process comprising:
a. A stack of several layers including hard-mask and targeted layers are deposited on top of the substrate.
b. Again it is important to choose a hard-mask material with high etching selectivity such that its shape will not change or only slight change will occur after the layers underneath are etched in both dry and wet methods.
c. A standard lithographic process is used in step (2) to print resist features with their pitch size (e.g., 3 F+3 F=6 F) equal to the minimum pitch size resolvable with a lithographic tool. A following anisotropic plasma etching will transfer the resist pattern to the hard-mask and targeted layers as shown in step (3).
d. After this, an isotropic etching (which can be either wet or dry, but will not attack the hard-mask layer) will undercut the targeted layer such that the width of the left targeted layer underneath the hard-mask layer is exactly 1 F as shown in step (4).
e. A deposition (step (5)) of the sacrificial material will fill the undercut cavities followed by an anisotropic plasma etching to remove the sacrificial materials in the trenches as shown in step (6). The width of the sacrificial material underneath the hard-mask layer is 1 F on both sides assuming the hard-mask layer does not change its shape during the etchings.
f. After this, the targeted material will be deposited to fill the trenches as shown in step (7), followed by an anisotropic plasma etching to form the targeted-material side walls leaving the trenches' width of about 1 F as shown in step (8).
g. Finally, a CMP process will be used to polish off the top layers to expose the targeted and sacrificial materials as shown in step (9).
h. After releasing the sacrificial material by either wet or dry etching, a dense line/space structure with pitch size equal to 2 F is obtained and shown in step (10). This pitch size (2 F) is ⅓ of the original pitch size (6 F) which corresponds to the minimum resolution limit of a conventional lithographic system.

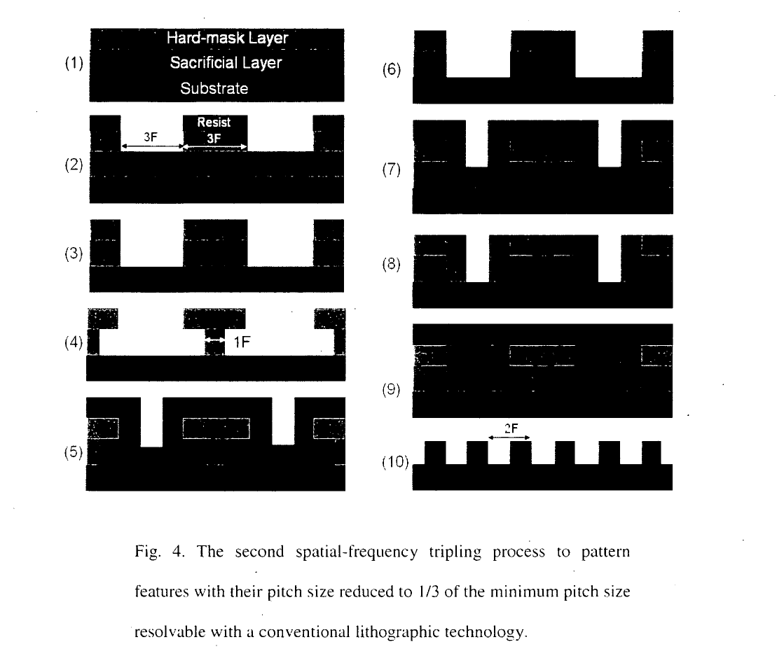

4. The second process to achieve the spatial-frequency tripling is shown FIG. 4, the process comprising:
a. A stack of several layers including hard-mask and sacrificial layers are deposited on top of the substrate.
b. A hard-mask material with high etching selectivity should be chosen such that its shape will not change or only slight change will occur after the layers underneath are etched in both dry and wet methods.
c. A standard lithographic process is used in step (2) to print resist features with their pitch size (e.g., 3 F+3 F=6 F) equal to the minimum pitch size resolvable with a lithographic tool. A following anisotropic plasma etching will transfer the resist pattern to the hard-mask and sacrificial layers as shown in step (3).
d. After this, an isotropic etching (which can be either wet or dry, but will not attack the hard-mask layer) will undercut the sacrificial layer such that the width of the left sacrificial layer underneath the hard-mask layer is exactly 1 F as shown in step (4).
e. A deposition (step (5)) of the targeted material will fill the undercut cavities followed by an anisotropic plasma etching to remove the targeted materials in the trenches as shown in step (6). The width of the targeted material underneath the hard-mask layer is 1 F on both sides assuming the hard-mask layer does not change its shape during the etchings.
f. After this, the sacrificial material will be deposited to fill the trenches as shown in step (7), followed by an anisotropic plasma etching to form the sacrificial side walls leaving the trenches' width of about I F as shown in step (8).
g. These trenches are filled with the targeted material in step (9).
h. Finally, a CMP process is used to polish off the top layers to expose the targeted and sacrificial materials.
i. After releasing the sacrificial material by either wet or dry etching, a dense line/space structure with pitch size equal to 2 F is obtained and shown in step (10). This pitch size (2 F) is ⅓ of the original pitch size (6 F) which corresponds to the minimum resolution limit of a conventional lithographic system.
